(19) United States
(12) Patent Application Publication
(10) Pub. No.: US 2022/0383187 A1
(43) Pub. Date: Dec. 1, 2022

(54) SYSTEM AND METHOD FOR DETECTING NON-COMPLIANCES BASED ON SEMI-SUPERVISED MACHINE LEARNING

(71) Applicant: VMWARE, INC., Palo Alto, CA (US)

(72) Inventors: Kiran Rama, Bangalore (IN); Giridhar Rao, Bangalore (IN)

(21) Appl. No.: 17/389,453

(22) Filed: Jul. 30, 2021

(30) Foreign Application Priority Data
May 26, 2021 (IN) 202141023429

(51) Int. Cl. G06N 20/00; G06K 9/62

(52) U.S. Cl. CPC G06N 20/00; G06K 9/6265; G06K 9/6259; G06K 9/6297; G06K 9/6277; G06K 9/623

(57) ABSTRACT

A system and method for detecting non-compliances using machine learning uses anomaly detection on an input dataset of unlabeled observations to produce output observations with corresponding probability scores of the output observations being anomalous. A portion of the output observations are labeled as being compliant observations based on the corresponding probability scores, which are added to a training dataset of compliant and non-compliant observations to derive an augmented dataset of compliant and non-compliant observations. The augmented dataset of compliant and non-compliant observations is then used to train a machine learning model for non-compliance detection.

Benefit is claimed under 35 U.S.C. 119(a)-(d) to Foreign Application Serial No. 202141023429 filed in India entitled “SYSTEM AND METHOD FOR DETECTING NON-COMPLIANCES BASED ON SEMI-SUPERVISED MACHINE LEARNING”, on May 26, 2021, by VMware, Inc., which is herein incorporated in its entirety by reference for all purposes.

### BACKGROUND

Compliance is a significant problem for various enterprises that sell products and/or services, such as software companies. Examples of compliance problems include software license piracy, intermediate vendor non-compliance and revenue leakage in service providing partners. Software license piracy may involve using illegal license keys generated by fraudulent original equipment manufacturers (OEMs), using duplicate licenses, using per-CPU licenses for unauthorized number of CPUs, over-using CPUs like using a 2X license for a 4X task, changing hardware without buying a new license, signing end-user license agreements with partners instead of vendors and purchasing licenses from a country with a lower price for use in another country. Intermediate vendor non-compliance may involve agreed-upon discounts that are not fully passed back to end customers. Revenue leakage in service providing partners may involve service providing partners, who share revenue from end customer usage of software services with the software companies, underreporting the total revenue from customer usage.

Detection of non-compliances using machine learning has many challenges. One of the challenges is that, since only small number of non-compliances are detected, most of the available data for training is unlabeled. Moreover, only historically anomalous data (non-compliant licenses, non-compliant partners, etc.) is detected and stored, which means only positive-class labeled examples are available for machine learning training. Additional labeling would be a costly exercise both in terms of cost and time. Furthermore, in order to get additional labeling, vendors or partners may need to be audited, which would be difficult with respect to legal requirements and more importantly with respect to business relationships.

### SUMMARY

A system and method for detecting non-compliances using machine learning uses anomaly detection on an input dataset of unlabeled observations to produce output observations with corresponding probability scores of the output observations being anomalous. A portion of the output observations are labeled as being compliant observations based on the corresponding probability scores, which are added to a training dataset of compliant and non-compliant observations to derive an augmented dataset of compliant and non-compliant observations. This algorithm adds labeled observations to a dataset of mostly unlabeled observations, thereby converting a largely unsupervised machine learning problem into a supervised one. The augmented training dataset of compliant and non-compliant observations is then used to train a machine learning model for non-compliance detection.

A computer-implemented method for detecting non-compliances using machine learning in accordance with an embodiment of the invention comprises executing anomaly detection on an input dataset of unlabeled observations to produce output observations with corresponding probability scores of the output observations being anomalous, labeling a portion of the output observations as being compliant-labeled observations based on the corresponding probability scores, adding the compliant-labeled observations to a training dataset of compliant and non-compliant observations to derive an augmented dataset of compliant and non-compliant observations, and training a machine learning model with the augmented training dataset of compliant and non-compliant observations for non-compliance detection. In some embodiments, the steps of this method are performed when program instructions contained in a non-transitory computer-readable storage medium are executed by one or more processors.

A system for detecting non-compliances using machine learning in accordance with an embodiment of the invention comprises memory and at least one processor configured to execute anomaly detection on an input dataset of unlabeled observations to produce output observations with corresponding probability scores of the output observations being anomalous, label a portion of the output observations as being compliant-labeled observations based on the corresponding probability scores, add the compliant-labeled observations to a training dataset of compliant and non-compliant observations to derive an augmented dataset of compliant and non-compliant observations, and train a machine learning model with the augmented training dataset of compliant and non-compliant observations for non-compliance detection.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a non-compliance detection system in accordance with an embodiment of the invention.

FIG. 2 is a block diagram of a machine learning (ML) model training system in accordance with an embodiment of the invention.

FIG. 3 is a process flow diagram of an operation for building an ML non-compliance detection model that is executed by the ML model training system in accordance with an embodiment of the invention.

FIG. 4A is a block diagram of a multi-cloud computing system in which the non-compliance detection system and/or the ML model training system may be implemented in accordance with an embodiment of the invention.

FIG. 4B shows an example of a private cloud computing environment that may be included in the multi-cloud computing system of FIG. 4A.

FIG. 4C shows an example of a public cloud computing environment that may be included in the multi-cloud computing system of FIG. 4A.

FIG. 5 is a flow diagram of a computer-implemented method for detecting non-compliances using machine learning in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

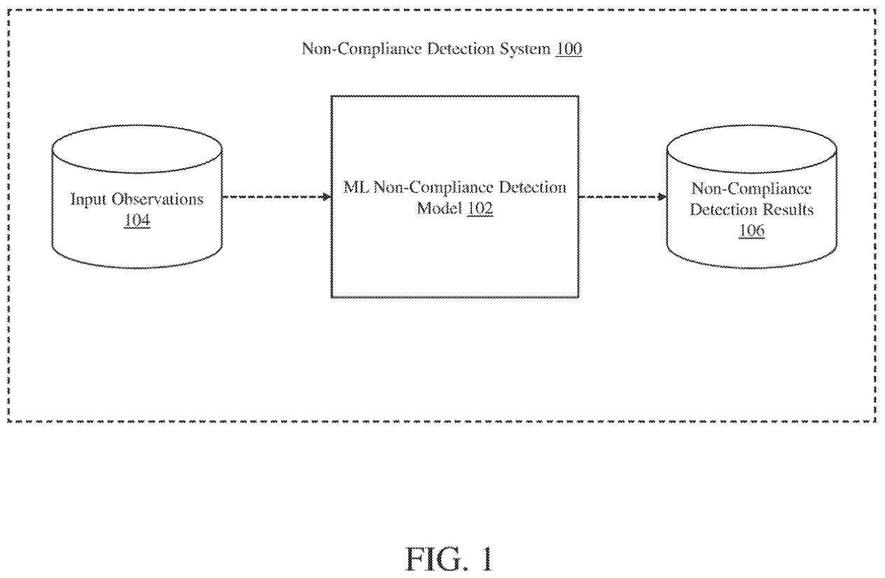

FIG. 1 shows a non-compliance detection system 100 in accordance with an embodiment of the invention. The non-compliance detection system 100 uses a machine learning (ML) non-compliance detection model 102 to process input observations 104 to produce non-compliance detection results 106. The non-compliance detection results 106 indicate which observations are likely to be non-compliant observations and compliant observations. In some embodiments, the non-compliance detection results 106 may provide a probability or confidence of each observation being a non-compliant observation, which may be provided as a non-compliance probability score. As explained below, the ML non-compliance detection model 102 is trained using anomaly detection to increase the training dataset for non-compliant observations.

Anomalies are data points that are significantly different from the remainder of the data. It is quite rare to find use cases where every observation in the dataset has a label. Unsupervised (with no labels) and semi-supervised scenarios (with only a few labels) are more common. In the real world, most of the datasets are unlabeled or insufficiently labeled and usually, labels are only from “discovered” anomalies forming unsupervised or semi-supervised learning problems respectively. Additional labeling is a “costly” exercise in terms of resources and time. The approaches for anomaly detection in both unsupervised and semi-supervised datasets involve one or more factors including reconstruction errors, distance measures, non-parametric statistical methods, data partitioning and local outlier factors. In typical semi-supervised datasets, the labels are available for a very small percentage of the observations. In many cases, the labels are present only for the minority positive class. The unavailability of labels for both classes and the presence of very few labels makes it difficult to build a reliable supervised model using only the labeled data. As described herein, embodiments of the invention use a training technique that is based on converting the anomaly detection problem in a semi-supervised dataset into a supervised one. By doing so, the performance over traditional anomaly detection techniques on semi-supervised datasets is improved, which can be applied to non-compliance detection.

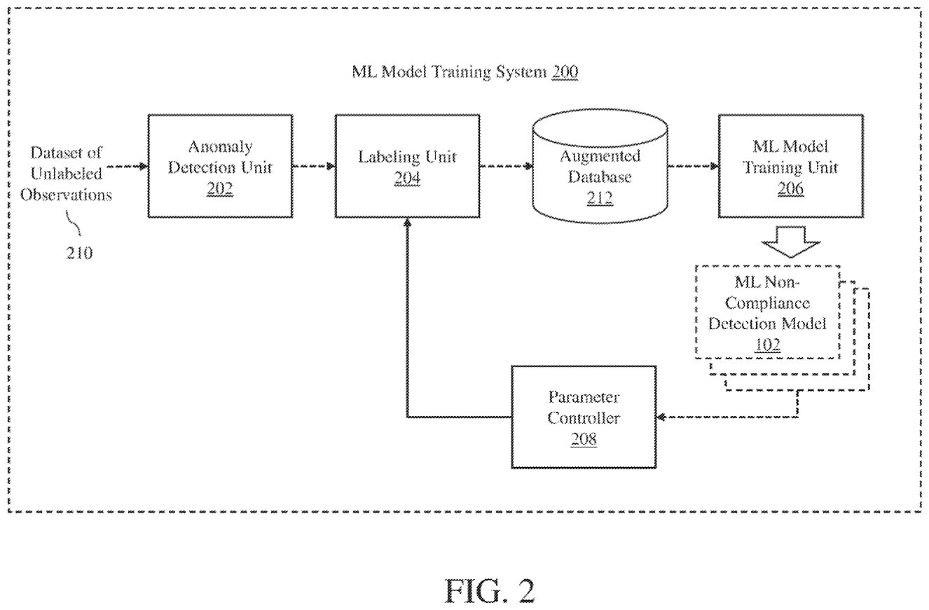

FIG. 2 shows an ML model training system 200 in accordance with an embodiment of the invention. The ML model training system 200 operates to train an ML model to derive the ML non-compliance detection model 102 used in the non-compliance detection system 100. The ML model training system 200 includes an anomaly detection unit 202, a labeling unit 204, an ML model training unit 206 and a parameter controller 208. In some embodiments, these components of the ML model training system 200 may be implemented as software running in one or more computing systems. In a particular implementation, these components of the ML model training system 200 may be running in a public cloud computing environment.

The anomaly detection unit 202 of the ML model training system 200 operates to process a dataset 210 of unlabeled observations to produce an anomaly score for each observation or data point of the unlabeled dataset. The anomaly score for an observation indicates the confidence or probability of the observation being an anomalous data point. In an embodiment, the anomaly scores for the observations that are output by the anomaly detection unit 202 are sorted in the order of decreasing confidence of the observations being anomalous from top to bottom. Thus, if lower anomaly score of an observation indicates lower confidence of the observation being anomalous, the output observations are sorted in the order of decreasing anomaly score from top to bottom. In this embodiment, the bottom observations would be the most likely to be normal or non-anomalous data points. However, in another embodiment, the observations that are output by the anomaly detection unit 202 may be sorted in the opposite order, i.e., the order of decreasing confidence of the observations being anomalous from bottom to top. In this embodiment, the top observations would be the most likely to be normal or non-anomalous data points.

The anomaly detection unit 202 may use any known anomalous detection techniques to process the dataset 210 of unlabeled observations. As an example, the anomaly detection unit 202 may use a proximity-based, statistical-based, reconstruction error-based and/or classification based algorithm for anomalous detection. Proximity-based algorithm may include a distance-based algorithm, such as a k-nearest neighbors (kNN) based algorithm, a density-based algorithm, such as a local outlier factor (LOF) algorithm, and a clustering-based algorithm, such as a cluster-based local outlier factor (CBLOF) algorithm. Statistical-based algorithm may include a parametric algorithm, such as a Gaussian algorithm, and a non-parametric algorithm, such as a histogram-based outlier score (HBOS) algorithm. Reconstruction error-based algorithm may include a subspace-based algorithm, such as a principal component analysis (PCA) reconstruction algorithm, a deep learning algorithm, such as an autoencoder algorithm, and a heuristic weighted autoencoder algorithm. Classification-based algorithm may include an isolation tree algorithm and a one class support vector machine (SVM) algorithm. These algorithms are existing anomaly detection methods, which all fit into the framework of the ML modeling training system 200. However, a superior anomaly detection method than these existing anomaly detection methods may be used in the anomaly detection unit 202. In a particular embodiment, the anomaly detection unit 202 may use a heuristic weighted autoencoder technique described in U.S. patent application Ser. No. 17/176,206, filed on Feb. 16, 2021, which is incorporated by reference herein.

The labeling unit 204 of the ML model training system 200 operates to selectively label some of the processed observations from the anomaly detection unit 202 that are likely to be non-anomalous as compliant observations. These observations are selected using the anomalous scores for the output observations that are generated by the anomaly detection unit 202, as explained further below. The resulting labeled observations can then be used as part of a training dataset for the ML model training unit 206 to train one or more ML models using supervised learning for non-compliance detection. In an embodiment, the selected and labeled observations from the output of the anomaly detection unit 202 are added to an existing labeled dataset of compliant and non-compliant observations to produce an augmented dataset 212 of compliant and non-compliant observations. Thus, the number of labeled compliant observations can be significantly increased by using the results from the anomaly detection unit 202 that are likely to be non-anomalous. This is an innovative manner of converting an unsupervised machine learning problem into a supervised one.

In an embodiment, if the anomaly scores for observations that are output from the anomaly detection unit 202 are sorted in the order of decreasing confidence of the observations being anomalous from top to bottom, some of the bottom output observations are selected by the labeling unit 204 and labeled as compliant observations. The number of bottom output observations that are selected and labeled as compliant observations may be based on a percentage of the output observations. As an example, the bottom 5%, 10% or 20% of the output observations that are ordered using the anomaly scores may be selected and labeled as compliant observations. The exact percentage may be empirically determined by selecting the percentage that results in the best or desired overall performance. This exact percentage is treated as a hyper-parameter in model tuning. The optimal percentage will be the number that provides the best performance on the holdout/validation dataset.

In another embodiment, if the anomaly scores for observations that are output from the anomaly detection unit 202 are sorted in the order of decreasing confidence of the observations being anomalous from bottom to top, some of the top output observations are selected by the labeling unit 204 and labeled as compliant observations. The number of top output observations that are selected and labeled as compliant observations may be based on a percentage of the output observations. As an example, the top 5%, 10% or 20% of the output observations that are ordered using the anomaly scores may be selected and labeled as compliant observations. Again, the exact percentage may be empirically determined by selecting the percentage that results in the best or desired overall performance. As explained above, the exact percentage is treated as a hyper-parameter in modeling and is the value that delivers the best performance on the holdout/validation dataset.

The ML model training unit 206 operates to use the augmented dataset 212 of labeled compliant and non-compliant observations to train an ML model using any known supervised learning algorithm to derive the ML non-compliance detection model 102. As an example, Random Forest or XGBoost supervised learning may be used by the ML model training unit 206 to train the ML model.

The resulting ML non-compliance detection model 102 trained by the ML model training unit 206 can be used to classify observations as compliant or non-compliant observations. However, the performance of the ML non-compliance detection model 102 with respect to accuracy will depend on the output observations of the anomaly detection unit 202 that are selected and labeled by the labeling unit 204 to be used as part of the augmented labeled dataset 212 for training of an ML model to create the ML non-compliance detection model 102. In an embodiment, the “x” value for the percentage of the bottom or top output observations, whichever are the most probable non-anomalous observations, from the anomaly detection unit 202 that are selected and labeled by the labeling unit 204 is used as a hyperparameter of the ML model training system 200. This hyperparameter may be automatically adjusted by the parameter controller 208 of the ML model training system 200 to finely tune the resulting ML non-compliance detection model 102 to improve its performance.

The parameter controller 208 operates to adjust the “x” percentage hyperparameter used by the labeling unit 204 to select and label a portion of the output observations from the anomaly detection unit 202 as compliant observations. By changing the “x” percentage hyperparameter used by the labeling unit 204, different output observations from the anomaly detection unit 202 will be labeled as compliant observations and added to the existing labeled dataset of compliant and non-compliant observations to produce the augmented dataset 212. Thus, the training dataset used by the ML model training unit 206, which is the augmented dataset 212, will be different for each set value of the “x” percentage hyperparameter, which translates into a different ML non-compliance detection model 102 that is produced by the ML model training unit 206.

In order to determine the optimal ML non-compliance detection model 102 produced by the ML model training unit 206, the parameter controller 208 operates to run a performance test on each of the produced ML non-compliance detection models. The performance test of each of the ML non-compliance detection models produced by the ML model training unit 206 is executed using a validation dataset of compliant and non-compliant observations. In an embodiment, the validation dataset may be a subset of the existing labeled dataset of compliant and non-compliant observations. In other embodiments, the validation dataset may be different than the existing labeled dataset of compliant and non-compliant observations. The model performance may be evaluated by the parameter controller 208 using any known technique, such as an analysis using Area Under Curve (AUC) metric, that is used for supervised learning typically. However, any other metric such as F-score can also be used.

In an embodiment, the parameter controller 208 may adjust the “x” percentage hyperparameter incrementally within a predefined range to produce a corresponding number of ML non-compliance detection models. In this embodiment, after the ML non-compliance detection models are produced, the performance each of these ML non-compliance detection models with respect to accuracy is computed to select the ML non-compliance detection model with the best performance. In other embodiments, the parameter controller 208 may adjust the “x” percentage hyperparameter from a starting value to another value one at a time until the ML non-compliance detection model with the best or desired performance is found. In these embodiments, the “x” percentage hyperparameter may be incrementally increased or decreased from the starting value by the parameter controller 208.

The mathematical formulation of the approach used by the ML model training system 200 is now described. Let the input be denoted by X, which is an n×m matrix with n rows and m columns. A very small portion of the dataset, Xₗ, is a labeled dataset and Xᵤ is the unlabeled dataset such that X=Xᵤ+Xₗ. Further, the majority and minority class examples in Xₗ are denoted as Xₗ₀ and Xₗ₁ respectively, such that Xₗ=X₀+Xₗ₁. The anomaly detection algorithm function is denoted as AD(D) that takes as input a dataset D and returns the observations D in their decreasing likelihood of being anomalies, which are denoted as D_{ranked}. A supervised learning classifier is denoted as SL.

In the first stage, the anomaly detection algorithm is run on the unlabeled observations, as shown below in equation (1):

X_{u_ranked}=AD(Xᵤ) Equation (1)

The bottom x % of X_{u_ranked} represent the least likely to be anomalous observations. These observations are added to the labeled dataset, as shown below in equations (2) and (3).

X_{bottom_u_ranked}=⊂_{bottom_x %}X_{u_ranked} Equation (2)

X_{augmented}=Xₗ+X_{bottom_u_ranked} Equation (2)

The supervised learning classifier is then run on Xₗ, as shown below in equation (4).

classifier=SL(X_{augmented}) Equation (4)

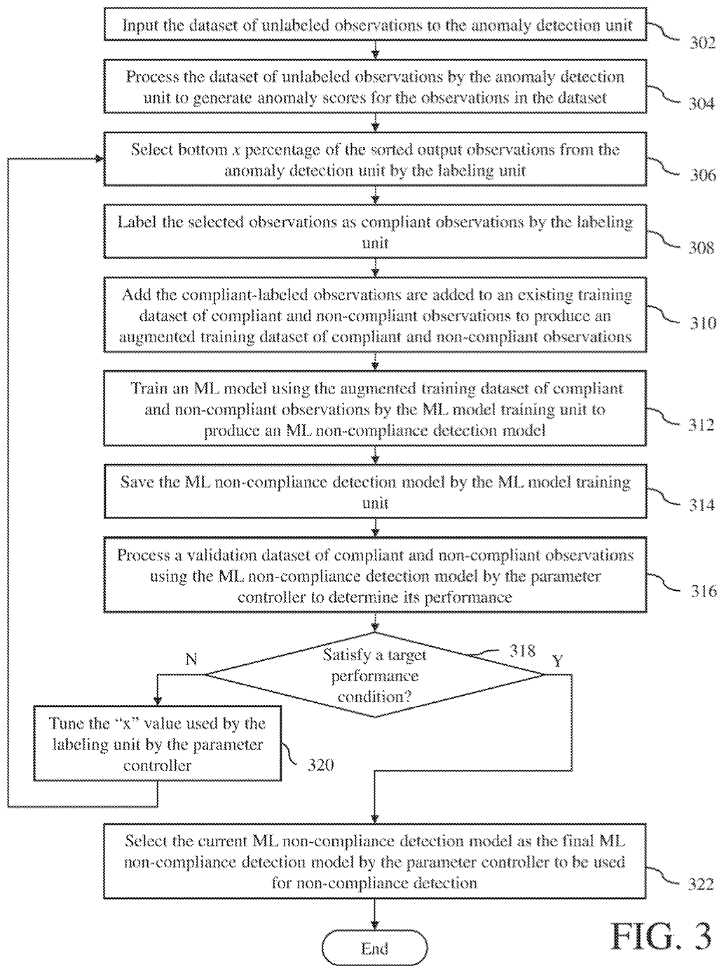

FIG. 3 is a process flow diagram of an operation for building an ML non-compliance detection model 102 that is executed by the ML model training system 200 in accordance with an embodiment of the invention. The operation begins at step 302, where the dataset 210 of unlabeled observations is input to the anomaly detection unit 202.

Next, at step 304, the dataset 210 of unlabeled observations is processed by the anomaly detection unit 202 to generate anomaly scores for the observations in the dataset, where each anomaly score indicates a probability that the associated observation is an anomalous observation. The processed or output observations are sorted by the anomaly detection unit 202 based on their generated anomaly scores in the order of decreasing probability or confidence of the observations being anomalous from top (first) to bottom (last). In an alternative embodiment, the processed observations may be sorted in the order of decreasing probability of the observations being anomalous from bottom (first) to top (last). The anomaly detection unit 202 may use a proximity-based, statistical-based, reconstruction error-based and/or classification based algorithm for anomalous detection to generate the anomaly scores for the observations in the dataset. In a particular implementation, the anomaly detection unit 202 may use a heuristic weighted autoencoder technique described in U.S. patent application Ser. No. 17/176,206, filed on Feb. 16, 2021, which can produce superior results over well-known anomaly detection techniques.

Next, at step 306, bottom x percentage of the sorted output observations from the anomaly detection unit 202 are selected by the labeling unit 204. In this embodiment, the output observations from the anomaly detection unit 202 are sorted such that the anomaly scores of the observations are in the order of decreasing confidence of the observations being anomalous from top to bottom. Initially, the “x” value may be set to a default value. In other embodiments, the “x” value may be set to a value determined by the parameter controller 208. In an alternative embodiment, top x percentage of the sorted output observations from the anomaly detection unit 202 are selected by the labeling unit 204. In this alternative, the output observations from the anomaly detection unit 202 are sorted such that the anomaly scores of the observations are in the order of decreasing confidence of the observations being anomalous from bottom to top.

Next, at step 308, the selected observations are labeled as compliant observations by the labeling unit 204. Next, at step 310, the compliant-labeled observations are added to an existing training dataset of compliant and non-compliant observations to produce an augmented training dataset 212 of compliant and non-compliant observations. Thus, the original training dataset is significantly expanded with the newly-labeled compliant observations.

Next, at step 312, an ML model is trained using the augmented training dataset of compliant and non-compliant observations by the ML model training unit 206 to produce an ML non-compliance detection model. Next, at step 314, the ML non-compliance detection model is saved by the ML model training unit 206.

Next, at step 316, a validation dataset of compliant and non-compliant observations is processed using the ML non-compliance detection model by the parameter controller 208 to determine the performance of the ML classification model with respect to accuracy in the classification of compliant and non-compliant observations. In an embodiment, the performance of the ML non-compliance detection model may be determined using an AUC analysis.

Next, at step 318, a determination is made by the parameter controller 208 whether the performance of the ML non-compliance detection model satisfies a target condition. As an example, the target condition may be a minimum model performance. As another example, the target condition may be that the performance of the current ML classification model is the best among a group of ML classification models generated by the ML model training unit 206 and evaluated by the parameter controller 208.

If the current ML non-compliance detection model does satisfy the target performance condition, then the operation proceeds to step 322, where the current ML classification model is selected as the final ML non-compliance detection model by the parameter controller 208 to be used for non-compliance detection. The operation then comes to an end.

However, if the current ML non-compliance detection model does not satisfy the target performance condition, then the operation proceeds to step 320, where the “x” hyperparameter value used by the labeling unit 204 is changed by the parameter controller 208. Depending on a scheme being used by the ML model training system 200, the “x” value may be raised or lowered. The operation then proceeds back to step 306, where the bottom x percentage of the sorted observations from the anomaly detection unit 202 are selected by the labeling unit 204. Since the value of x has changed, the output observations from the anomaly detection unit 202 that are selected and then labeled as compliant observations by the labeling unit 204 will also change, which will alter the augmented training dataset 212 of compliant and non-compliant observations that will be used to train an ML mode to produce the next ML non-compliance detection model. This process will be repeated until the final ML non-compliance detection model for non-compliance detection is determined by the parameter controller 208.

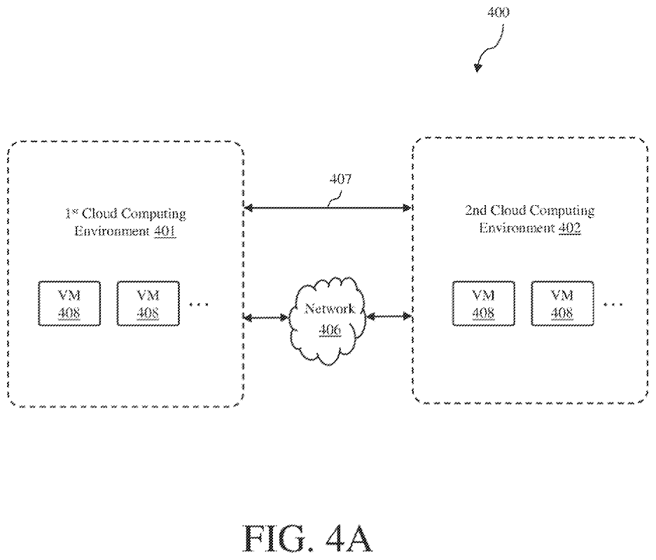

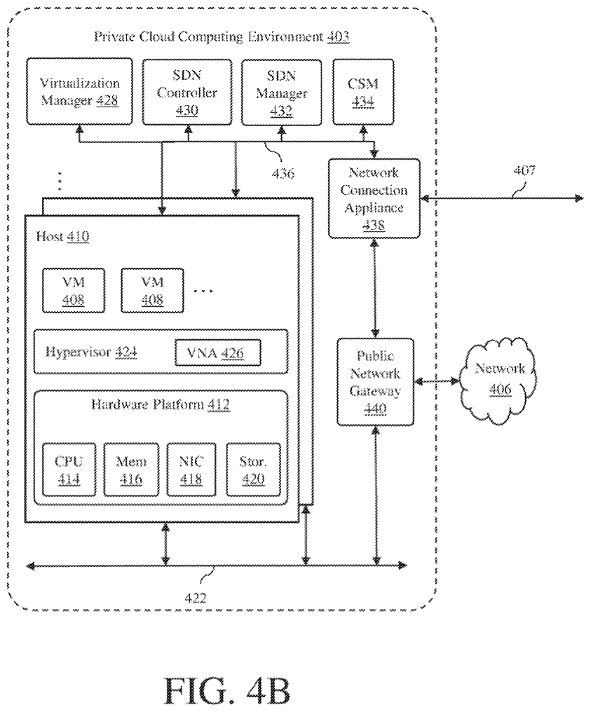

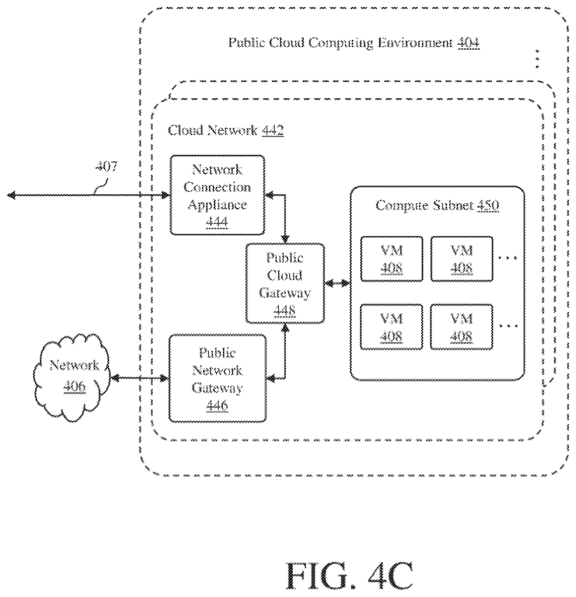

Turning now to FIG. 4A, a multi-cloud computing system 400 in which the non-compliance detection system 100 and/or the ML model training system 200 may be implemented in accordance with an embodiment of the invention is shown. The computing system 400 includes at least a first cloud computing environment 401 and a second cloud computing environment 402, which may be connected to each other via a network 406 or a direction connection 407. The multi-cloud computing system is configured to provide a common platform for managing and executing workloads seamlessly between the first and second cloud computing environments. In an embodiment, the first and second cloud computing environments may both be private cloud computing environments to form a private-to-private cloud computing system. In another embodiment, the first and second cloud computing environments may both be public cloud computing environments to form a public-to-public cloud computing system. In still another embodiment, one of the first and second cloud computing environments may be a private cloud computing environment and the other may be a public cloud computing environment to form a private-to-public cloud computing system. In some embodiments, the private cloud computing environment may be controlled and administrated by a particular enterprise or business organization, while the public cloud computing environment may be operated by a cloud computing service provider and exposed as a service available to account holders or tenants, such as the particular enterprise in addition to other enterprises. In some embodiments, the private cloud computing environment may comprise one or more on-premises data centers.

The first and second cloud computing environments 401 and 402 of the multi-cloud computing system 400 include computing and/or storage infrastructures to support a number of virtual computing instances 408. As used herein, the term “virtual computing instance” refers to any software entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being VMs, although embodiments of the invention described herein are not limited to VMs. These VMs running in the first and second cloud computing environments may be used to implement the non-compliance detection system 100 and/or the ML model training system 200.

An example of a private cloud computing environment 403 that may be included in the multi-cloud computing system 400 in some embodiments is illustrated in FIG. 4B. As shown in FIG. 4B, the private cloud computing environment 403 includes one or more host computer systems (“hosts”) 410. The hosts may be constructed on a server grade hardware platform 412, such as an x86 architecture platform. As shown, the hardware platform of each host may include conventional components of a computing device, such as one or more processors (e.g., CPUs) 414, memory 416, a network interface 418, and storage 420. The processor 414 can be any type of a processor, such as a central processing unit. The memory 416 is volatile memory used for retrieving programs and processing data. The memory 416 may include, for example, one or more random access memory (RAM) modules. The network interface 418 enables the host 410 to communicate with another device via a communication medium, such as a physical network 422 within the private cloud computing environment 403. The physical network 422 may include physical hubs, physical switches and/or physical routers that interconnect the hosts 410 and other components in the private cloud computing environment 403. The network interface 418 may be one or more network adapters, such as a Network Interface Card (NIC). The storage 420 represents local storage devices (e.g., one or more hard disks, flash memory modules, solid state disks and optical disks) and/or a storage interface that enables the host 410 to communicate with one or more network data storage systems. Example of a storage interface is a host bus adapter (HBA) that couples the host 410 to one or more storage arrays, such as a storage area network (SAN) or a network-attached storage (NAS), as well as other network data storage systems. The storage 420 is used to store information, such as executable instructions, virtual disks, configurations and other data, which can be retrieved by the host 410.

Each host 410 may be configured to provide a virtualization layer that abstracts processor, memory, storage and networking resources of the hardware platform 412 into the virtual computing instances, e.g., the VMs 408, that run concurrently on the same host. The VMs run on top of a software interface layer, which is referred to herein as a hypervisor 424, that enables sharing of the hardware resources of the host by the VMs. These VMs may be used to execute various workloads. Thus, these VMs may be used to implement the non-compliance detection system 100 and/or the ML model training system 200.

One example of the hypervisor 424 that may be used in an embodiment described herein is a VMware ESXi™ hypervisor provided as part of the VMware vSphere® solution made commercially available from VMware, Inc. The hypervisor 424 may run on top of the operating system of the host or directly on hardware components of the host. For other types of virtual computing instances, the host 410 may include other virtualization software platforms to support those processing entities, such as Docker virtualization platform to support software containers. In the illustrated embodiment, the host 410 also includes a virtual network agent 426. The virtual network agent 426 operates with the hypervisor 424 to provide virtual networking capabilities, such as bridging, L3 routing, L2 Switching and firewall capabilities, so that software defined networks or virtual networks can be created. The virtual network agent 426 may be part of a VMware NSX® logical network product installed in the host 410 (“VMware NSX” is a trademark of VMware, Inc.). In a particular implementation, the virtual network agent 426 may be a virtual extensible local area network (VXLAN) endpoint device (VTEP) that operates to execute operations with respect to encapsulation and decapsulation of packets to support a VXLAN backed overlay network.

The private cloud computing environment 403 includes a virtualization manager 428, a software-defined network (SDN) controller 430, an SDN manager 432, and a cloud service manager (CSM) 434 that communicate with the hosts 410 via a management network 436. In an embodiment, these management components are implemented as computer programs that reside and execute in one or more computer systems, such as the hosts 410, or in one or more virtual computing instances, such as the VMs 408 running on the hosts.

The virtualization manager 428 is configured to carry out administrative tasks for the private cloud computing environment 402, including managing the hosts 410, managing the VMs 408 running on the hosts, provisioning new VMs, migrating the VMs from one host to another host, and load balancing between the hosts. One example of the virtualization manager 428 is the VMware vCenter Server® product made available from VMware, Inc.

The SDN manager 432 is configured to provide a graphical user interface (GUI) and REST APIs for creating, configuring, and monitoring SDN components, such as logical switches, and edge services gateways. The SDN manager allows configuration and orchestration of logical network components for logical switching and routing, networking and edge services, and security services and distributed firewall (DFW). One example of the SDN manager is the NSX manager of VMware NSX product.

The SDN controller 430 is a distributed state management system that controls virtual networks and overlay transport tunnels. In an embodiment, the SDN controller is deployed as a cluster of highly available virtual appliances that are responsible for the programmatic deployment of virtual networks across the multi-cloud computing system 400. The SDN controller is responsible for providing configuration to other SDN components, such as the logical switches, logical routers, and edge devices. One example of the SDN controller is the NSX controller of VMware NSX product.

The CSM 434 is configured to provide a graphical user interface (GUI) and REST APIs for onboarding, configuring, and monitoring an inventory of public cloud constructs, such as VMs in a public cloud computing environment. In an embodiment, the CSM is implemented as a virtual appliance running in any computer system. One example of the CSM is the CSM of VMware NSX product.

The private cloud computing environment 403 further includes a network connection appliance 438 and a public network gateway 440. The network connection appliance allows the private cloud computing environment to connect another cloud computing environment through the direct connection 407, which may be a VPN, Amazon Web Services® (AWS) Direct Connect or Microsoft® Azure® ExpressRoute connection. The public network gateway allows the private cloud computing environment to connect to another cloud computing environment through the network 406, which may include the Internet. The public network gateway may manage external public Internet Protocol (IP) addresses for network components in the private cloud computing environment, route traffic incoming to and outgoing from the private cloud computing environment and provide networking services, such as firewalls, network address translation (NAT), and dynamic host configuration protocol (DHCP). In some embodiments, the private cloud computing environment may include only the network connection appliance or the public network gateway.

An example of a public cloud computing environment 404 that may be included in the multi-cloud computing system 400 in some embodiments is illustrated in FIG. 4C. The public cloud computing environment 404 is configured to dynamically provide cloud networks 442 in which various network and compute components can be deployed. These cloud networks 442 can be provided to various tenants, which may be business enterprises. As an example, the public cloud computing environment may be AWS cloud and the cloud networks may be virtual public clouds. As another example, the public cloud computing environment may be Azure cloud and the cloud networks may be virtual networks (VNets).

The cloud network 442 includes a network connection appliance 444, a public network gateway 446, a public cloud gateway 448 and one or more compute subnetworks 450. The network connection appliance 444 is similar to the network connection appliance 438. Thus, the network connection appliance 444 allows the cloud network 442 in the public cloud computing environment 404 to connect to another cloud computing environment through the direct connection 407, which may be a VPN, AWS Direct Connect or Azure ExpressRoute connection. The public network gateway 446 is similar to the public network gateway 440. The public network gateway 446 allows the cloud network to connect to another cloud computing environment through the network 406. The public network gateway 446 may manage external public IP addresses for network components in the cloud network, route traffic incoming to and outgoing from the cloud network and provide networking services, such as firewalls, NAT and DHCP. In some embodiments, the cloud network may include only the network connection appliance 444 or the public network gateway 446.

The public cloud gateway 448 of the cloud network 442 is connected to the network connection appliance 444 and the public network gateway 446 to route data traffic from and to the compute subnets 450 of the cloud network via the network connection appliance 444 or the public network gateway 446.

The compute subnets 450 include virtual computing instances (VCIs), such as VMs 408. These VMs run on hardware infrastructure provided by the public cloud computing environment 404, and may be used to execute various workloads. Thus, these VMs may be used to implement the non-compliance detection system 100 and/or the ML model training system 200.

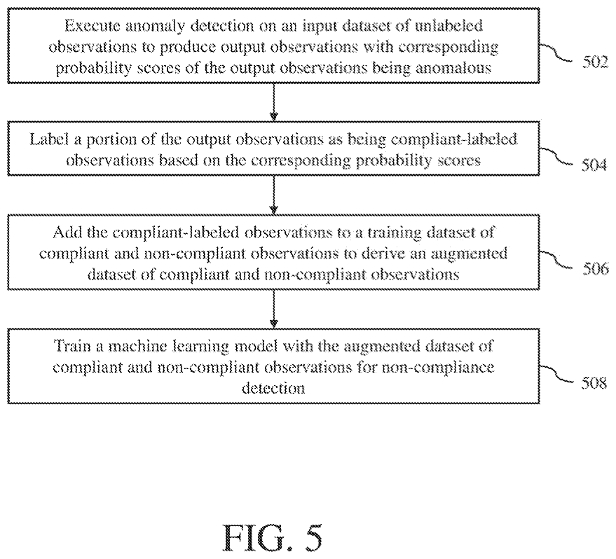

A computer-implemented method for detecting non-compliances using machine learning in accordance with an embodiment of the invention is described with reference to a flow diagram of FIG. 5. At block 502, anomaly detection is executed on an input dataset of unlabeled observations to produce output observations with corresponding probability scores of the output observations being anomalous. At block 504, a portion of the output observations are labeled as being compliant-labeled observations based on the corresponding probability scores. At block 506, the compliant-labeled observations are added to a training dataset of compliant and non-compliant observations to derive an augmented dataset of compliant and non-compliant observations. At block 508, a machine learning model is trained with the augmented dataset of compliant and non-compliant observations for non-compliance detection.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for detecting non-compliances using machine learning, the method comprising:
executing anomaly detection on an input dataset of unlabeled observations to produce output observations with corresponding probability scores of the output observations being anomalous;
labeling a portion of the output observations as being compliant-labeled observations based on the corresponding probability scores;
adding the compliant-labeled observations to a training dataset of compliant and non-compliant observations to derive an augmented dataset of compliant and non-compliant observations; and
training a machine learning model with the augmented dataset of compliant and non-compliant observations for non-compliance detection.

2. The method of claim I, wherein labeling the portion of the output observations as being compliant-labeled observations includes labeling x percentage of the output observations having lowest probability scores of being anomalous as the compliant-labeled observations.

3. The method of claim 2, wherein labeling the x percentage of the output observations having the lowest probability scores includes labeling bottom x percentage of the output observations in a ranked order of the output observations as the compliant-labeled observations, wherein the output observations in the ranked order are ordered such that the output observation with the highest probability of being anomalous is at the top of the ranked order and the output observation with the lowest probability of being anomalous is at the bottom of the ranked order.

4. The method of claim 2, further comprising:
validating the machine learning model trained with the augmented dataset of compliant and non-compliant observations to determine a performance of the machine learning model with respect to accuracy;
in response to the determined performance of the machine learning model, changing the value of x in the x percentage of the output observations having the lowest probability scores to change the output observations that are labeled as the compliant-labeled observations to create a different augmented dataset of compliant and non-compliant observations for non-compliance detection; and
training another machine learning model with the different augmented dataset of compliant and non-compliant observations for non-compliance detection.

5. The method of claim 4, wherein validating the machine learning model includes evaluating the performance of the machine learning model using area under curve (AUC) metric.

6. The method of claim 1, wherein executing the anomaly detection on the input dataset of unlabeled observations includes executing the anomaly detection on an input dataset of unlabeled observations using a proximity-based, a statistical-based, a reconstruction error-based or a classification-based algorithm to produce the output observations with the corresponding probability scores of the output observations being anomalous.

7. The method of claim 1, wherein training the machine learning model includes training the machine learning model with the augmented dataset of compliant and non-compliant observations using a supervised learning algorithm.

8. A non-transitory computer-readable storage medium containing program instructions for a method for detecting non-compliances using machine learning, wherein execution of the program instructions by one or more processors of a computer causes the one or more processors to perform steps comprising:
executing anomaly detection on an input dataset of unlabeled observations to produce output observations with corresponding probability scores of the output observations being anomalous,
labeling a portion of the output observations as being compliant-labeled observations based on the corresponding probability scores;
adding the compliant-labeled observations to a training dataset of compliant and non-compliant observations to derive an augmented dataset of compliant and non-compliant observations; and
training a machine learning model with the augmented dataset of compliant and non-compliant observations for non-compliance detection.

9. The computer-readable storage medium of claim 8, wherein labeling the portion of the output observations as being compliant-labeled observations includes labeling x percentage of the output observations having lowest probability scores of being anomalous as the compliant-labeled observations.

10. The computer-readable storage medium of claim 9, wherein labeling the x percentage of the output observations having the lowest probability scores includes labeling bottom x percentage of the output observations in a ranked order of the output observations as the compliant-labeled observations, wherein the output observations in the ranked order are ordered such that the output observation with the highest probability of being anomalous is at the top of the ranked order and the output observation with the lowest probability of being anomalous is at the bottom of the ranked order.

11. The computer-readable storage medium of claim 9, wherein the steps further comprise:
validating the machine learning model trained with the augmented dataset of compliant and non-compliant observations to determine a performance of the machine learning model with respect to accuracy;
in response to the determined performance of the machine learning model, changing the value of x in the x percentage of the output observations having the lowest probability scores to change the output observations that are labeled as the compliant-labeled observations to create a different augmented dataset of compliant and non-compliant observations for non-compliance detection; and
training another machine learning model with the different augmented dataset of compliant and non-compliant observations for non-compliance detection.

12. The computer-readable storage medium of claim 11, wherein validating the machine learning model includes evaluating the performance of the machine learning model using area under curve (AUC) metric.

13. The computer-readable storage medium of claim 8, wherein executing the anomaly detection on the input dataset of unlabeled observations includes executing the anomaly detection on an input dataset of unlabeled observations using a proximity-based, a statistical-based, a reconstruction error-based or a classification-based algorithm to produce the output observations with the corresponding probability scores of the output observations being anomalous.

14. The computer-readable storage medium of claim 8, wherein training the machine learning model includes training the machine learning model with the augmented dataset of compliant and non-compliant observations using a supervised learning algorithm.

15. A system for detecting non-compliances using machine learning comprising:
memory; and
at least one processor configured to:
execute anomaly detection on an input dataset of unlabeled observations to produce output observations with corresponding probability scores of the output observations being anomalous;
label a portion of the output observations as being compliant-labeled observations based on the corresponding probability scores,
add the compliant-labeled observations to a training dataset of compliant and non-compliant observations to derive an augmented dataset of compliant and non-compliant observations; and
train a machine learning model with the augmented dataset of compliant and non-compliant observations for non-compliance detection.

16. The system of claim 15, wherein the at least one processor is configured to label x percentage of the output observations having lowest probability scores of being anomalous as the compliant-labeled observations.

17. The system of claim 16, wherein the at least one processor is configured to:
validate the machine learning model trained with the augmented dataset of compliant and non-compliant observations to determine a performance of the machine learning model with respect to accuracy;
in response to the determined performance of the machine learning model, change the value of x in the x percentage of the output observations having the lowest probability scores to change the output observations that are labeled as the compliant-labeled observations to create a different augmented dataset of compliant and non-compliant observations for non-compliance detection; and
train another machine learning model with the different augmented dataset of compliant and non-compliant observations for non-compliance detection.

18. The system of claim 17, wherein the at least one processor is configured to evaluate the performance of the machine learning model using area under curve (AUC) metric.

19. The system of claim 15, wherein the at least one processor is configured to execute the anomaly detection on an input dataset of unlabeled observations using a proximity-based, a statistical-based, a reconstruction error-based or a classification-based algorithm to produce the output observations with the corresponding probability scores of the output observations being anomalous.

20. The system of claim 15, wherein the at least one processor is configured to train the machine learning model with the augmented dataset of compliant and non-compliant observations using a supervised learning algorithm.
